(19) United States
(12) Patent Application Publication
(10) Pub. No.: US 2011/0039031 A1
(43) Pub. Date: Feb. 17, 2011

(54) CARRIER, FORMULATION AND METHOD FOR THE TREATMENT OF TIMBER

(75) Inventors: Peter Cobham, Queensland (AU); David Humphrey, Victoria (AU); Brett Skewes, Victoria (AU)

Correspondence Address: BELL & ASSOCIATES, 58 West Portal Avenue No. 121, SAN FRANCISCO, CA, 94127, US

(73) Assignee: Arch Wood Protection Pty Ltd

(21) Appl. No.: 12/989,417

(22) PCT Filed: Apr. 24, 2009
(86) PCT No.: PCT/AU09/00525

§ 371 Date: Oct. 24, 2010

(51) Int. Cl. C09D 5/14; B05D 1/02; B05D 1/28; B05D 1/18

(52) U.S. Cl. 427/427.7; 106/18; 106/311; 427/440; 427/428.01

(57) ABSTRACT

According to the present invention there is provided a carrier composition for migration and/or redistribution of a preservative formulation within wood or engineered wood products, said carrier system comprising a drying oil and/or a semi-drying oil and an extender. There is also provided a preservative formulation comprising such a carrier composition and a method of treating wood comprising the step of applying such a preservative formulation to the wood or engineered wood product.

### FIELD OF THE INVENTION

The present invention relates to preservative treatment of timber building materials and particularly, to carrier compositions, formulations and methods for delivering a protective envelope of said preservative to said timber.

### BACKGROUND OF THE INVENTION

Any discussion of the prior art throughout the specification should in no way be considered as an admission that such prior art is widely known or forms part of common general knowledge in the field.

Wood is a staple construction material used throughout the world. However, it is prone to degradation from elements including the natural environment, weather events, insects, rot and fire.

For instance, in countries such as Australia, timber is especially susceptible to termite attack. This has been counteracted to some degree by the treatment of wood with preservatives in the form of insecticides. Accordingly, a range of chemical treatments has been developed to improve the durability and available working lifetime of wooden structures. Application methods and approved chemicals vary significantly throughout the world.

Softwood timbers such as pinus radiata, pinus elliotti, and pinus carribea used as framing timber in Australia are especially susceptible to termite attack. Changes in Government regulations have limited the use of soil poisoning agents (e.g. banning of organochloride insecticides). This has unfortunately led to a higher incidence of termite attack in timber-framed houses. Accordingly, many countries continue to seek suitable cost-effective methods to combat this ever-increasing risk of termite attack.

One of the strategies to combat termite attack of softwood frames is the treatment of the timber with insecticides or more broad-spectrum wood preservatives. To this end, timber is often impregnated with a preservative such as a fungicide or insecticide. The preservative is typically present in a carrier, with the mixture being applied to the surface of the timber, for example by dipping, spraying or brushing, such that the carrier and preservative are absorbed in to the timber.

Examples of commonly used insecticides include synthetic pyrethroids. These are axonic poisons that work by keeping the sodium channels open in the neuronal membranes of insects. The sodium channel is a small hole through which sodium ions are permitted to enter the axon and cause excitation. As the nerves cannot then de-excite, the insect is rendered paralysed. However, as preservatives in an aqueous solvent for the treatment of timber, such components are still susceptible to leaching from the timber after treatment. Moreover, swelling of the timber after treatment due to water retention is a significant detriment. Examples of commercial pyrethroids include allethrin, bifenthrin, cypermethrin, cyphenothrin, deltamethrin, permethrin, prallethrin, resmethrin, sumithrin, tetramethrin, tralomethrin, transfluthrin and imiprothrin.

A selected carrier is required to be capable of providing sufficient penetration of the preservative into the wood, thereby to provide an effective barrier against infestation. Other considerations in the choice of carrier include the desired rate of penetration, the cost and environmental and health and safety considerations.

The treatment of timber or timber products with preservative compounds involves the introduction of stable chemicals into the cellular structure of the timber. This, in turn, protects the timber from hazards such as fungi, insects and other wood-destroying organisms. Preservative treatments may also include the introduction of chemicals that improve resistance to degradation by fire.

Preservative treatment of wood is usually carried out at increased pressure so as to force the liquid preservative solution into the pores of the wood. A vacuum may be applied prior to the introduction of the treatment solution in order to increase penetration. The active chemical agent is usually dissolved in a solvent and the solutions generally are of relatively low viscosity in order to facilitate the penetration of the treatment solution. However, the preservative may also be present in the carrier as an emulsion.

Increased penetration of the preservative solution can also be achieved by diffusion, which despite involving less expensive equipment does require a longer time period and greater levels of stock holding. Diffusion time is also influenced by the initial wood moisture content and often requires a pre-drying step so as to create a preferential diffusion gradient along which the preservative/carrier formulation may migrate.

In Australia, the treatment of timber is covered by the Australian standard “AS 1604-2007”. The present invention is especially applicable to Hazard classes H1, H2, H3 and H2F. Of these, Hazard class H2 is defined for the biological hazard—borer and termites and Hazard Class H3 is defined as being for protection against “moderate fungal decay and termite hazard for decking, fascia, cladding, window reveals, and exterior structure timber”. Although the present invention is exemplified with respect to H2 and H3 requirements, it will be readily appreciated by those skilled in the art that the invention is equally applicable to H1 and H2F requirements and penetration standard.

The approved chemicals are shown in the following table (retention is measured in w/w [% m/m]).

TABLE 1
Minimum Preservative Retention in the
Penetration Zone - Hazard Class 2 (H2)

| Waterborne | | | | |
|---|---|---|---|---|
| Copper chrome | Ammoniacal copper | Light organic solvent preservatives | | |
| arsenic (CCA) | quaternary | Per- | Cyper- | Delta- |
| (Cu + Cr + As) | (Cu + DDAC) | methrin | methrin | methrin |
| 0.320 | 0.35 | 0.020 | 0.030 | 0.0020 |

TABLE 2
Minimum Preservative Retention in the Penetration Zone - Hazard Class 3 (H3)
Waterborne
Light organic solvent preservatives

| | | | | TBTN | | | |
|---|---|---|---|---|---|---|---|
| | Cu + | Copper | | or | Propiconazole + | Copper | Synthetic |
| CCA | DDAC | azole | Creosote | TBTO | Tebuconazole | naphthenate | Pyrethroids |
| 0.380 | Soft: | 0.229 | 8.00 | 0.080 | Soft: 0.06 | 0.100 | 0.02 Permethrin |
| | 0.35 | | | 0.160 | Hard: _{—} | | 0.03 Cypermethrin |
| | Hard: | | | | | | 0.002 Deltamethrin |
| | 0.39 | | | | | | 0.0047 Bifenthrin |

“Penetration” is defined under the standard as: “[a]ll preservative-treated wood shall show evidence of distribution of the preservative in the penetration zone in accordance with the following requirements:
(a) If the species of timber used is of natural durability class 1 or 2, the preservative shall penetrate all the sapwood. Preservative penetration of the heartwood is not required.
(b) If the species of timber used is of natural durability class 3 or 4, the preservative shall penetrate all of the sapwood and, in addition one of the following requirements shall apply:
   (i) Where the lesser cross-sectional dimension is greater than 35 mm, the penetration shall be not less than 8 mm from any surface. Where the lesser cross-sectional dimension is equal or less then 35 mm, the penetration shall be not less than 5 mm from any surface.
   (ii) Unpenetrated heartwood shall be permitted, provided that it comprises less than 20% of the cross-section of the piece and does not extend more than halfway through the piece from one surface to the opposite surface and does not exceed half the dimension of the side in the cross-section on which it occurs”.

In order to provide for penetration of the preservative, a carrier must be used. As shown in the Australian standard (see, Tables 1 and 2, above), the carriers presently available can be characterised as “waterborne” or “solvent-borne” systems.

The preservatives commonly used in timber treatment can be characterised according to the carrier solvent used as the vehicle to carry preservatives into the timber, and by the active chemicals that provide the protection against the various hazards that compositions such as that of the present invention seek, to counter. The final step in the preservation process is that the solvent (which may possibly include water) must then be removed before the timber is made available for use.

Waterborne carriers swell wood and hence need to be re-dried prior to use in service. Australian Standards specify the maximum moisture content of pine framing. This level is around 12-14% w/w moisture content. The general process sequence is:
Dry wood→Water Treat→Re-dry wood

The additional re-drying step adds complexity and expense to the treatment process. This results in additional costs being passed on to the consumer.

By comparison, solvent-borne preservatives do not raise the moisture content and hence do not swell the wood because they are non-polar. Thus, the process sequence is:
Dry wood→Solvent treat

Although the use of solvent-borne preservatives mitigates against the need for the re-drying step, the principal disadvantages of this treatment system are the relatively high cost of solvents (cf water) and the potential environmental concerns with, e.g. volatile organic compounds being released into the atmosphere.

As mentioned above, the application of the preservative/carrier to the wood is often carried out by a batch process involving a pressure vessel. For water-borne preservatives, a vacuum pressure process (Bethell or MI cell) is used. This ensures, providing the wood is dry, complete sapwood penetration and adequate heartwood penetration if required.

Copper, chromium and arsenate (H₂AsO₄⁻), “CCA”, is a leach-resistant wood preservative that has been used for some time to treat solid wood in external applications. CCA impregnates the timber in a water/salts carrier and is designed to react with the wood cell components so that the active elements copper, chromium and arsenic are “fixed” into the wood's structure. The arsenic component protects the sapwood from insect attack; the copper and arsenic from degradation due to fungi, whilst the chromium component chemically locks the elements into the timber, offering a relatively high resistance to leaching. Following such treatment, in order to give the treated timber dimensional stability, it must be re-dried. This process can decrease the strength of the timber, and invariably adds to the cost. However, due to environmental health and safety issues—and toxicity concerns relating to the constituent metals, especially arsenic, CCA is coming under increasing regulation and is thus becoming a less desirable treatment on both commercial and environmental bases.

Inorganic boron compounds have been used in Australia for more than forty years to protect the sapwood of susceptible hardwoods against lyctid or “powder post” borers. Such treatment consists in soaking freshly-sawn unseasoned timber in solutions of boron salts. The salts diffuse through the timber, thereby treating it, and after such treatment, the timber is allowed to dry. However, boron salts are readily soluble in aqueous solutions and can be leached relatively easily from the wood once treated. This largely restricts boron-treated timber to interior uses such as flooring or joinery, wherein it is protected from the external environment.

Light Organic Solvent-borne Preservatives (LOSP) comprise a light organic solvent, typically white spirit, to carry the preservative chemicals into the timber. White spirit is a mixture of saturated aliphatic and alicyclic C₇-C₁₂ hydrocarbons with a w/w content of about 15-20% aromatic C₇-C₁₂ hydrocarbons. The solvent is drawn out in the final stages of treatment, with the preservative remaining within the wood.

Such preservatives are typically fungicides, having copper, tin, zinc, azoles and pentachlorophenols (PCPs) as major toxicants. Synthetic pyrethroids such as bifenthrin may be incorporated within the preservative composition if an insect hazard is also present. One principal advantage of LOSP treatment is that the treated timber does not swell, making such treatment quite suitable for treatment of finished items such as mouldings and joinery. The majority of LOSPs used in wood treatment also contain insecticides and/or waxes so as to give the surface water repellent properties.

However, as previously stated, the active ingredients in LOSPs are carried into the timber by a hydrocarbon solvent; typically white spirits. Odour and exposure to VOCs (volatile organic compounds) are significant environmental and occupational health and safety issues associated with the use of LOSPs in the timber industry. Accordingly, whilst effective, such treatments are becoming increasingly undesirable.

Alkaline Copper Quat (ACQ) contains copper and a quaternary ammonium compound. It is used to protect timber against decay, fungi and insects. ACQ is applied as a water-borne preservative using an external pressure process. It is free of arsenic and is used to treat external timber applications.

Copper azole is another of the new generation of arsenic-free preservative treatments that can be used in water-borne pressure treatment processes. It is a preservative that contains copper, boric acid and tebuconazole. Copper azole has been used in Australia as a replacement for CCA for treatments having external end applications.

Creosote and PEC (pigment emulsified creosote) are commonly used oil-borne preservatives that are painted on to timber surfaces, but can also be applied in a pressure-based process for better penetration. These compounds have volatile components and hence, a characteristic odour. This makes creosote and PEC only really suitable for use in external or industrial applications.

As the use of water-based carriers has been found to increase the moisture content of the timber, resulting in undesirable swelling of the wood; and necessitating a further drying processes after treatment, many current methods of treating and protecting wood, for H2 and H3 end uses, rely on using non-aqueous solvents. Further, pressure plants are expensive to construct, and being batch processes, conventional treatments do not match well with continuous sawmill production and require a high level of operator control to maintain costs.

One such composition for the treatment of timber is Tanalith-T® (inter alia, U.S. Pat. No. 7,361,215, U.S. Ser. No. 10/865,041, EP 01 270 411.0, JP 4,256,162 and AU 2002215690, each to the present Applicant). “Tan-T” uses a drying oil in combination with a high flash point solvent carrier to transport the insecticide, for example deltamethrin or permethrin into the wood. This formulation promotes the formation 6f a well-defined “envelope” of preservative, thereby treating and preventing infestations of termites and other insects.

The existing product Tanalith-T® is a mixture of pale boiled linseed oil (PBLO) and narrow cut kerosene (NCK). This solution, with permethrin as a preservative/termiticide has proven excellent in giving the required protective envelope at low uptake (12 to 15 L/m³).

Of late, the cost of both PBLO and NCK has risen as a result of the commodity boom and cost of mineral oil. For instance, linseed oil typically costs around US$1400-1800/ton. Accordingly, with the increasing cost of both vegetable (i.e. “drying: and “semi-drying”) and mineral oils, there remains a need for the development of carriers that can provide a protective envelope similar to that of the presently-used vegetable oil/mineral oil carrier systems, whilst preferably at once minimising the increase in moisture content of the timber as a result of the treatment, and without need for further drying steps.

U.S. Pat. No. 5,846,305, to Payzant, discloses a liquid wood preservative solution including copper metal, liquid amine solvent, a boron compound and a glycol. Glycol has been used as a replacement for water in ancient timber restoration, or for dimensional stability in a technique known as “bulking” for many years. Boron is highly miscible in glycol and thus the movement of a glycol/boron solution into the wood is due to diffusion. Due to the length of time required for adequate diffusion into the wood, this type of preservative is required to be forced into the wood by vacuum pressure and is unsuitable for effective use in more time-effective techniques such as brushing, dipping or spraying.

International Patent Publication No. WO 02/081159, to Lonza A G, relates to a method for the protective treatment of wood by means of thermal treatment at 60-250° C. and additional treatment using an amine and/or amine derivative and/or salt thereof. The wood treated according to such method has good resistance even to harmful organisms that cannot be reliably controlled by means of only a heat treatment. The method is carried out without compounds containing heavy metals and the wood treated in this way has no impact on the environmental either during the use or during the disposal thereof. However, it will be appreciated that the initial heat-treatment step is relatively undesirable for cost-energy reasons.

International Patent Publication No. WO 2004/050783, to Osmose Australia Pty Ltd, summarises known methods for glue, glue line resin systems and wood products incorporating glues with bifenthrin. Methods are disclosed for the application of such glue and resin systems with bifenthrin. The glues with bifenthrin are effective for preserving wood including engineered wood products, with or without additional surface sprays. The bifenthrin is delivered to the wood in a water-based formulation by spraying.

Herein and throughout the specification and claims, the terms “biosolvent” and “biofuel” are used interchangeably to define a heating oil substitute made generally from transesterfied lipids of edible and non-edible oils. Biofuels are obtained from relatively recently lifeless biological material, and in some cases, living matter.

“First-generation biofuels” are those made from sugar, starch, vegetable oil, or animal fats using conventional technology. The basic feedstocks for the production of first generation biofuels are often seeds or grains such as wheat, which yields starch that is fermented into bioethanol, or sunflower seeds, which are pressed to yield vegetable oil that can be used in biodiesel.

According to the present invention, one of the most preferred biofuels is biodiesel (although the present invention is equally applicable to other biofuels such as bioalcohols, bioethers, second and third generation biofuels, etc.). Biodiesel refers to a non-petroleum-based diesel fuel consisting of long-chain alkyl (methyl, propyl or ethyl) esters. Bio diesel is made by chemically-reacting lipids, typically vegetable oil or animal fat (tallow), and alcohol. By “long chain” is intended to mean C₆ or greater, preferably C₈ or greater, more preferably C₁₀ or greater, branched or straight chain. Examples of preferred biodiesels include methyl linoleate (produced from soybean or canola oil and methanol) and ethyl stearate (produced from soybean or canola oil and ethanol).

Chemically, trans-esterified biodiesel comprises a mix of mono-alkyl esters of long chain fatty acids. The most common form uses methanol (converted to sodium methoxide) to produce methyl esters as it is the cheapest alcohol available, though ethanol can be used to produce an ethyl ester biodiesel and higher alcohols such as isopropanol and butanol have also been used. Using alcohols of higher molecular weights improves the cold flow properties of the resulting ester, at the cost of a less efficient transesterification reaction. A lipid transesterification production process is used to convert the base oil to the desired esters. Any free fatty acids (FFAs) in the base oil are either converted to soap and removed from the process, or they are esterified (yielding more biodiesel) using an acidic catalyst. After this processing, unlike straight vegetable oil, biodiesel has combustion properties very similar to those of petroleum diesel, and can replace it in most current uses.

The iodine value is a measure of the amount of unsaturation contained in fatty acids. This unsaturation is in the form of double bonds which react with iodine compounds. The higher the iodine number, the more unsaturated fatty acid bonds are present in a fat. Preferred fats and oils from which the biodiesels applicable to the present invention are derived have an iodine value typically within the range of about 90 to about 110.

Biodiesel can be used (alone, or blended with conventional petrodiesel) in unmodified diesel-engine vehicles. Biodiesel is distinguished from the straight vegetable oil (SVO) (a.k.a. “waste vegetable oil”, “WVO”, “unwashed biodiesel”, “pure plant oil”, “PPO”) used (alone, or blended) as fuels in some converted diesel vehicles. “Biodiesel” is standardised as mono-alkyl esters and other non-diesel fuels of biological origin are not included.

Blends of biodiesel and conventional hydrocarbon-based diesel are products most commonly distributed for use in the retail marketplace. Biodiesel can also be used in its pure form (B100).

Amongst its other uses, biodiesel can be used as a heating fuel in domestic and commercial boilers. Older furnaces may contain rubber parts that would be affected by biodiesel's solvent properties, but can otherwise burn biodiesel without any conversion required.

A variety of oils can be used to produce biodiesel. These include virgin oil feedstock (rapeseed and soybean oils are most commonly used, soybean oil alone accounting for about ninety percent of all fuel stocks in the US). Biodiesel may also can be obtained from field pennycress and Jatropha other crops such as mustard, flax, sunflower, palm oil, hemp; waste vegetable oil (WVO); animal fats including tallow, lard, yellow grease, chicken fat, and the by-products of the production of omega-3 fatty acids from fish oil; algae, which can be grown using waste materials such as sewage and without displacing land currently used for food production; oil from halophytes such as salicornia bigelovii, which can be grown using saltwater in coastal areas where conventional crops cannot be grown, with yields, equal to the yields of soybeans and other oilseeds grown using freshwater irrigation.

Popular theory is that waste vegetable oil is the best source of oil to produce biodiesel, but since the available supply is drastically less than the amount of petroleum-based fuel that is burned for transportation and home heating in the world, this local solution does not scale well.

By “vegetable oils” is intended to encompass all vegetable oils that are extracted from plants, i.e. essential, pressed, leached and macerated oils. A non-exhaustive and exemplary list of oils from with “biodiesel” can be sourced is as follows: castor oil, coconut oil, corn oil, cottonseed oil, false flax oil, hemp oil, mustard oil, canola oil, palm oil, peanut oil, radish oil, rapeseed oil, ramtil oil, rice bran oil, safflower oil, salicornia oil, soybean oil, sunflower oil, tung oil, algae oil, copaiba, honge oil, jatropha oil, jojoba oil, milk bush, petroleum nut oil, walnut oil, sunflower oil, dammar oil, linseed oil, poppyseed oil, stillingia oil, vernonia oil, castor oil, aniur cork tree fruit oil, balanos oil, bladderpod oil, brucea javanica oil, burdock oil, candlenut oil, carrot seed oil, chaulmoogra oil, crambe oil, cuphea oil, lemon oil, mango oil, mowrah butter, neem oil, ojon oil, orange oil, palm oil, rosehip seed oil, sea buckthorn oil, shea butter, snowball seed oil, tall oil, tamanu oil, tonka bean oil.

The potential health effects of inhaling biodiesel are negligible, as are those of skin contact and ingestion. Contact with eyes causes mere irritation. Biodiesel is considered readily biodegradable under ideal conditions and non-toxic.

Biodiesel has additional benefits along with being from a renewable resource. For instance, the fried food revolution in China ensures a bountiful supply of biodiesel at relatively'low cost. Biodiesel has a relatively low odour, relatively low volatile organic compound discharge and a relatively high flash point (>120° C.).

In view of the properties and advantages provided by biodiesel, it would appear to have potential as a carrier system for active ingredients in the wood treatment industry.

It is an object of the present invention to overcome or ameliorate at least one of the disadvantages of the prior art, or to provide a useful alternative.

It is an object of an especially preferred form of the present invention to provide for a material and method for the preservative treatment of timber products that is preferably effective in addressing the “re-cut timber” problem and provides for an approximate 5 mm mobile envelope of preservative within the treated wood.

Despite the many and varied techniques for the treatment of wood, there remains a need to satisfy the “dry after” requirement for treated timber, having less than 15% moisture content, whilst achieving the required penetration of active compounds into the wood.

Additionally, remains a need for a material for treating wood that has relatively low odour, relatively minimal VOC emissions, and relatively less reliance on mineral spirits, whilst at once providing relatively good dimensional stability to the treated wood.

Further still, price fluctuations in mineral oils are somewhat volatile. A cheaper and substantially efficacious alternative could relatively insulate the retail price of Tanalith-T® from price movement in mineral oil.

Unless the context clearly requires otherwise, throughout the description and the to claims, the words “comprise”, “comprising”, and the like are to be construed in an inclusive sense as opposed to an exclusive or exhaustive sense; that is to say, in the sense of “including, but not limited to”.

Although the invention will be described with reference to specific examples it will be appreciated by those skilled in the art that the invention may be embodied in many other forms.

### SUMMARY OF THE INVENTION

According to a first aspect of the present invention there is provided a carrier composition for migration and/or redistribution of a preservative formulation within wood, said carrier composition comprising:

(a) a drying oil and/or a semi-drying oil; and

(b) an extender comprising one or more biosolvents.

In an embodiment, said one or more biosolvents is in the form of biodiesel. Preferably, said biodiesel has relatively low odour, relatively low volatile organic compound discharge and a relatively high flash point (>120° C.). However, any biosolvent having a flash point is above the flammable limit (61° C.) is potentially amenable to the present invention.

In an embodiment, the carrier composition further comprises one or more drying agents to accelerate drying of said drying oil and/or said semi-drying oil. Preferably, said one or more drying agents is selected from the group consisting of: cobalt, manganese, zirconium, copper naphthenate, and mixtures thereof.

In an embodiment, said drying oil is linseed oil, fish oil, or the like. Preferably, said drying oil is linseed oil. Preferably, the drying oil is non-swelling.

In an embodiment, said semi-drying oil is corn oil, cottonseed oil, sesame oil, or the like. Preferably, said semi-drying oil is sesame oil. Preferably, the semi-drying oil is non-swelling.

In an embodiment, said extender is present in an amount between about 1 and 99% w/w (i.e. the lower limit of the amount of each of the components of the carrier composition is about 1% w/w). Preferably, said extender is present in an amount between about 10 and 90% w/w, Preferably, said extender is present in an amount between about 30 and 70% w/w. More preferably, said extender is present in an amount between about 40 and 60% w/w. Most preferably, said extender is present in an amount of about 50% w/w.

In an especially preferred embodiment, the carrier composition comprises as the drying oil, the non-edible oil jatropha (iodine value ca. 95-110), one or more drying agents such as copper naphthenate, and a biodiesel/biosolvent derived for jatropha.

In another especially preferred embodiment, the carrier composition comprises pale boiled linseed oil and soy oil as the drying/semi-drying oil component, and a biosolvent augmented by narrow cut kerosene, etc.

In an embodiment, said carrier is selected to remain mobile within said wood for up to several months. Preferably, said carrier is selected to remain mobile within said wood for up to about four weeks. More preferably, said carrier is selected to remain mobile within said wood for up to about two weeks.

In an embodiment, said carrier migrates and/or redistributes within said wood to exposed surfaces thereof. This is termed the “self healing” effect. Preferably, said carrier migrates and/or redistributes along the grain of said wood and/or across said grain.

According to a second aspect of the present invention there is provided a formulation for treating wood comprising a preservative and a carrier composition, said carrier composition as defined according to the first aspect of the present invention, said formulation thereby mobile within the wood and providing for migration of the preservative within the wood to exposed surfaces thereof.

In an embodiment, said preservative is selected from the group consisting of: insecticides, termiticides, fungicides, mouldicides, or the like, and mixtures thereof.

In an embodiment, said preservative is an insecticide selected from the group consisting of organochlorine compounds, organophosphates, synthetic pyrethroids, neonicotinoids and biological insecticides.

Preferably, said preservative is selected from the group consisting of: synthetic pyrethroids; neonicotinoids such as acetamiprid, clothianidin, dinotefuran, imidacloprid, nitenpyram, thiacloprid and thiamethoxam; iodopropynylbuthylcarbamate (IPBC); organic tin compounds such as tributyltin naphthenate (TBTN); organic copper compounds such as copper 8 quinolinolate, copper naphthenate; organic zinc compounds quaternary ammonium compounds; tertiary ammonium compounds; isothiazolones; triazoles such as tebuconazol; boron compounds; 3-benzothien-2-yl-5,6-dihydro-1,4,2-oxathiazine-4-oxide (Bethogard®); bis-(N-cyclohexyldiazenuimdioxy) copper (“Cu-HDO”); and mixtures thereof.

Throughout the specification and claims, reference to metal compounds, e.g. copper naphthenate, or zinc compounds should be taken to mean that the compound may be present in solution, nano, macronised or micronised form. Further, with reference to the preservatives, these may be present in solution, emulsion, micronised, macronised or any other form in which they may migrate and be active within the wood.

In an embodiment, said synthetic pyrethroids are selected from the group consisting of allethrin, bifenthrin, cypermethrin, cyphenothrin, deltamethrin, permethrin, prallethrin, resmethrin, sumithrin, tetramethrin, tralomethrin, transfluthrin, imiprothrin and mixtures thereof. In another preferred embodiment, said neonicotinoid is thiacloprid or imidacloprid.

In an embodiment, the formulation comprises below about 5% w/w preservative content. Preferably, the formulation comprises below about 2% w/w preservative content. More preferably, the formulation comprises below about 1% w/w preservative content.

In an especially preferred embodiment, the preservative is a mixture of termiticides, e.g. permethrin and bifenthrin. In another embodiment, two or more types of termiticides are used, e.g. one being a repellent (e.g. permethrin) and the other a poison (e.g. imidacloprid). In another embodiment, the preservative is a mixture of a small amount of azole (i.e. a fungicide) with imidacloprid.

According to a third aspect of the present invention there is provided a method of treating wood, said method comprising the step of contacting said wood with a formulation as defined according to the second aspect of the present invention.

In an embodiment, said contacting step is effected by means selected from the group consisting of: pressure application, spraying, dipping, rolling and painting, and combinations thereof. Preferably, said contacting step is effected by means of dipping said wood in said formulation for a period of between a few seconds up to several minutes. More preferably, said contacting step is effected by means of dipping said wood in said formulation for a period of from around 5 seconds up to about 60 seconds.

In an embodiment, said wood is contacted with a sufficient quantity of said formulation to provide an uptake of between about 10 L/m³ to about 100 L/m³. Preferably, said wood is contacted with a sufficient quantity of said formulation to provide an uptake of between about 15 L/m³ to about 20 L/m³.

In an embodiment, said wood is selected from the group consisting of pinus radiata heartwood, pinus radiata sapwood, pinus elliottii heartwood, pinus elliottii sapwood, Douglas fir (psuedotsuga menziesii) heartwood and Douglas fir (psuedotsuga menziesii) sapwood.

In an embodiment, said wood comprises wood composites/engineered wood products selected from the group consisting of: particle board, plywood, medium density fibreboard (MDF) and oriented strand board (OSB).

According to a fourth aspect of the present invention there is provided a treated wood, when so-treated by a method according to the third aspect of the present invention.

According to a fifth aspect of the present invention there is provided a treated wood or wood composite comprising:
(a) wood boards, wood particles, fibres, plies, strands or mixtures thereof;
(b) one or more organic copper compounds;
(c) a carrier, said carrier being selected such that it remains mobile within the wood and provides for migration of said preservative within the treated wood, said carrier comprising:
   a drying oil selected from linseed oil, fish oil or the like and/or a semi-drying oil selected from corn oil, cottonseed oil, sesame oil or the like; and
   an extender comprising one or more biosolvents in the form of biodiesel having relatively low odour, relatively low volatile organic compound discharge and a relatively high flash point (>120° C.); and
(d) an optional drying agent,
   wherein the copper compounds are present in said wood in an amount effective to be a substantially permanent preservative of the treated wood.

According to a sixth aspect of the present invention there is provided a method of treating wood or wood composite, said method comprising the steps of
(a) providing wood boards, wood particles, fibres, plies, strands or mixtures thereof;
(b) adding a mixture comprising an organic copper compound, an optional drying agent, and a carrier, said carrier being selected such that it remains mobile within the wood and provides for migration of said preservative within the treated wood, said carrier comprising:
   a drying oil selected from linseed oil, fish oil or the like and/or a semi-drying oil selected from corn oil, cottonseed oil, sesame oil or the like; and
   an extender, comprising one or more biosolvents in the form of bio diesel having relatively low odour, relatively low volatile organic compound discharge and a relatively high flash point (>120° C.),
   wherein the copper compounds are present in said wood in an amount effective to be a permanent preservative of the treated wood.

In an embodiment, the drying oil and/or semi-drying oil is non-swelling. In another embodiment, the wood boards, wood particles, fibres, plies, strands or mixtures thereof comprise a bonding agent to improve the bond strength of the resulting product.

According to a seventh aspect of the present invention there is provided a treated wood or wood composite, when so-treated by a method according to the sixth aspect of the present invention.

In an especially preferred embodiment of the invention, a minimum of about 10% w/w PBLO (i.e. the drying oil) is added to the biodiesel to form the carrier composition. Alternatively however, the biodiesel may be used as a single carrier. This is providing that the viscosity of the biodiesel alone is approximately equal to current treatment materials such as Tanalith-T®

The extender is in the form of one or more biosolvents, most preferably being biodiesel having relatively low odour, relatively low volatile organic compound discharge and a relatively high flash point (>120° C.). The carrier composition remains mobile in the wood for a considerable period of time thereby allowing for migration of the preservative.

A wide variety of preservatives may also be used in combination with the carrier biodiesel. Various insecticides and termiticides known in the art may be mixed with the carrier composition. Such insecticides and termiticides include synthetic pyrethroids such as permethrin, cypermethrin, etc., and imidacloprid.

Fungicides and mouldicides may also be used, e.g. iodopropynylbutyl carbamate (IPBC), tributyltin naphthenate (TBTN) and the class of mouldicides known as isothiazolones. Other fungicides and mouldicides applicable to the present invention include iodopropynylbuthylcarbamate (IPBC), organic tin compounds such as tributyltin naphthenate, organic copper compounds such as copper 8 quinolinolate and copper naphthenate, organic zinc compounds, quaternary ammonium compounds, tertiary ammonium compounds, isothiazolones, triazoles such as tebuconazole, boron compounds such as trimethyl borate.

In a preferred embodiment, the preservative is 3-benzothien-2-yl-5,6-dihydro-1,4,2-oxathiazine-4-oxide (Bethogard®), bis-(N-cyclohexyldiazenuimdioxy) copper (“Cu-HDO”) or permethrin.

The combination of preservative and carrier system as defined according to the present invention allows the inventive formulation to be used as a permanent preservative as defined by Hazard classes H2, H2F, H3, H4 and H5 in Australian Standard “AS1604-2007”, America Wood Preserves Association Standards (USA) and “MP 3640” (New Zealand).

Drying agents such as cobalt, manganese, zirconium and copper naphthenate may be added to accelerate the drying of the drying oil and/or semi-drying oil, if required. For the avoidance of doubt, the term “drying oil” as applied to the present invention defines an oil that hardens to a tough, solid film after a period of exposure to air. The term “drying” is therefore something of a misnomer—the oil does not harden through the evaporation of water or other solvents, but through a chemical polymerisation reaction in which oxygen is absorbed from the environment (autoxidation) and the fatty acid chains link with each other to form an extremely large cross-linked polymer.

Moreover, the drying oil present in the carrier composition can be substituted with a semi-drying oil. A “semi-drying” oil is an oil which only partially hardens when it is exposed to air, as opposed to a to “drying” oil, which hardens completely, or a non-drying oil, which does not harden at all. Oils with an iodine number of 115-130 are considered semi-drying, e.g. corn oil, cottonseed oil and sesame oil, each of which is applicable to the present invention.

Moreover, both “drying oil” and “semi-drying oil” is intended to encompass the “natural” oil itself, as well as chemical modifications thereof, for instance, linseed oil that has been converted to resins, etc.

The Applicant has found that the above-defined formulation comprising a mixture of preservative and carrier composition provides an effective wood preservative which has the sought “self healing” effect. Since the carrier composition remains mobile within the wood, it is capable of redistributing the active components of the preservative. This redistribution or migration of the carrier/preservative mixture will generally occur along the grain of the wood, however, some distribution across the grain will also occur. In providing such a migratable formulation, it is not necessary for the ends of the timber to be retreated after cutting since the active components of the formulation will be provided to the freshly cut ends with the migrating carrier oil. This effect thereby addresses what is known in the art as the “sawn (or cut) timber problem”.

The present invention provides a significant advance over conventional preservative techniques. Previous materials essentially treat the wood, are re-dried and then remain “dormant” or fixed within the wood. The present inventive carrier, formulation and method provide for a “self healing” wood capable of “retreating” itself; and in particular, providing a preservative treatment to cut or damaged surface areas, which of course are the most common entry for termites and/or the most likely sites of fungal attack.

Migration/penetration of the preservative system occurs in both radial and tangential directions forming an envelope around the treated wood to a depth of around 5 mm. Such penetration in the tangential direction does not occur with waterborne preservatives. Further, such migration ensures a consistency of the envelope around the surface of the treated wood. The envelope may be formed in both the heartwood and the sapwood.

In another embodiment, the present invention provides a method of treating wood comprising contact the wood with a mixture of preservative and carrier composition, the carrier comprising one or more biosolvents in the form of biodiesel having relatively low odour, relatively low volatile organic compound discharge and a relatively high flash point (>120° C.), and remaining mobile within the wood such that it provides for migration of the preservative within the wood.

The treatment step can be conducted using conventional pressure application techniques such as existing vacuum pressure systems known in light organic solvent plants. Alternatively, the Applicant has also found the mixture of the preservative and carrier composition can be applied without the need for pressure application. Treatment can be accomplished by spraying, dipping, brushing, etc., which, unlike previous conventional batch systems, is ideal for use on continuous production line facilities such as saw mills.

The Applicant has also found that the inventive formulation and method provides more than adequate protection without the need for complete sapwood penetration as required under the Australian Standard.

As discussed earlier, the Australian Standard requires that irrespective of the species of timber, i.e. natural durability class 1 to 5, the preservative must penetrate all sapwood. The present invention rather uses an envelope-type protection rather than penetration throughout the sapwood. This 5 mm envelope is a move away from conventional techniques but still provides adequate protection for treated timber and with the use of a preservative/mobile carrier comprising one or more biosolvents results in the “self healing” effect.

The most preferred drying oil is linseed oil (at least 10% w/w PBLO). The linseed oil dries to form a water barrier and penetrates without the need for pressure. Advantageously, it is also low odour. Other drying oils such as fish oil may be used and other lightweight hydrocarbons, e.g. heating oil in the form of biodiesel may be used in limited quantities as an extender to the linseed or fish oil in order to reduce costs.

Another advantage of the carrier oil is its high boiling point/flash point that reduces vapour emissions in production and use. Of necessity, the carrier comprises one or more biosolvents in the form of biodiesel.

Another surprising benefit of using such a high boiling point carrier is its advantageous effect on migration of the preservative. It is believed that the relatively higher boiling point of the carrier/preservative mixture tends to allow the preservative to move inwards, as compared with more volatile solvents that migrate outwardly.

Of course, using such a non-swelling drying oil/extender composition also has the advantage that the treated wood/timber does not need to be re-dried, i.e. treatment can be accomplished by simple dipping of the wood for periods of say up to one minute.

Trials with radiata and elliottii pine have both achieved 5 mm envelope penetration following a one minute dipping time (see, Examples, below).

It is envisaged that other biosolvent carrier oils may also be used provided, that when mixed with the preservative they remain mobile within the wood to allow migration of the preservative. The present invention is also amenable to using blends of biodiesel and conventional hydrocarbon-based diesel.

### EXAMPLES

The following Examples should be viewed as representative only, and in no way limiting of the scope of the claims or efficacy of the present invention.

Tests were conducted to verify the efficacy of the above-defined formulation, including the mobility and self-healing characteristics of the preservative/carrier system previously described, wherein the carrier comprises one or more biosolvents in the form of biodiesel.

Radiata heartwood, radiata sapwood, elliottii (slash) heartwood and elliottii (slash) sapwood were sourced from various suppliers. Boards were cut into four separate 1 m lengths.

A drying oil (10% w/w PBLO linseed oil) used in combination with an extender in the form of one or more biosolvents in the form of biodiesel was used. The “test” preservative formulation also contained an addition of 0.01% w/w copper (present as copper naphthenate) as an indicator of the penetration.

The penetration samples were treated by first weighing the boards, and then dipping in a mixture of the preservative formulation with 0.01% w/w copper naphthenate for a period of one minute. They were allowed to drip until touch-dry. The boards were then re-weighed and stacked for 24 hours before being cut in half. The exposed surface on one half of the board was sprayed with indicator solution and photographed.

TABLE 3
Uptakes of Formulation in Radiata and
Elliottii Heartwoods and Sapwoods

| | | | Coefficient |
|---|---|---|---|
| Wood Type | Uptake | Standard Deviation | of Variation |
| Radiata heartwood | 17.89 | 3.5 | 19.67 |
| Radiata sapwood | 19.97 | 3.5 | 17.65 |
| Elliottii heartwood | 16.36 | 5.35 | 32.73 |
| Elliottii sapwood | 18.35 | 2.9 | 15.9 |

As shown in Table 3, resultant weights taken both before and after treatment show average uptakes for radiata heartwood at 18 L/m³, 20 L/m³ for radiata sapwood, 16 L/m³ for elliottii heartwood and 18 L/m³ for elliottii sapwood. Standard deviations were low and the coefficient of variation was less than 20 in all but the elliottii heartwood. This indicates that there is little variance in uptake of preservative into radiata heartwood and sapwood, and elliottii sapwood.

### BRIEF DESCRIPTION OF THE FIGURES

A preferred embodiment of the invention will now be described, by way of example only, with reference to the accompanying figures, which show the effect of the treatment on radiata heartwood, radiata sapwood, elliottii heartwood and elliottii sapwood at various times after treatment as follows:

FIGS. 1 to 4 show radiata heartwood, elliottii heartwood, radiata sapwood and elliottii sapwood, respectively, 24 h after treatment with the formulation described above;

FIGS. 5 to 8 are enlargements of the cut surface of the treated wood products shown in FIGS. 1 to 4, respectively, each of which shows a protective envelope to a depth of approximately 5 mm; and

FIGS. 9 to 12 show two stacks of the treated wood products, the lower stack being that shown in FIGS. 1 to 4 (i.e. 24 h after treatment) and the upper stacks being the same products 48 h after treatment.

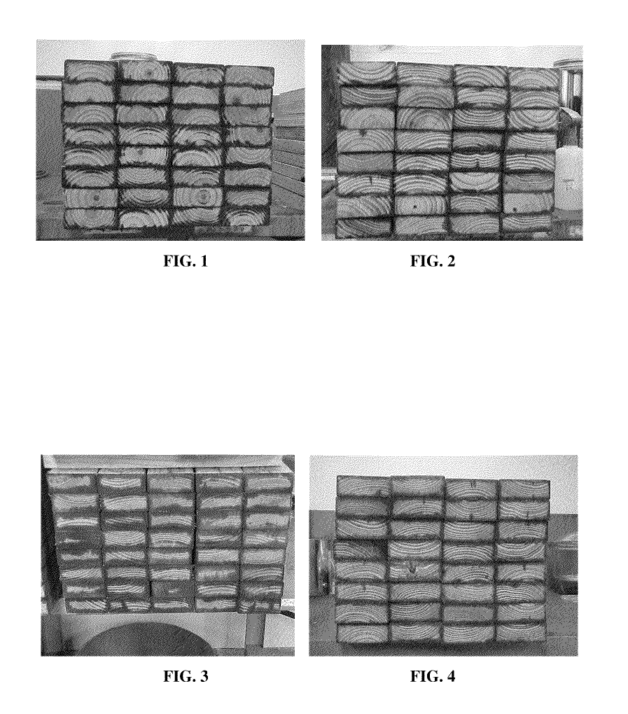

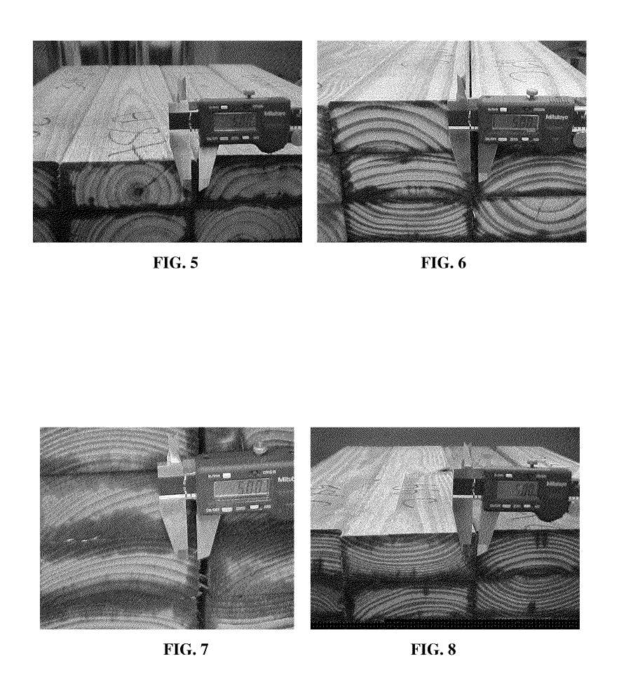

As shown in FIGS. 1 to 4 and more clearly in the respective FIGS. 5 to 8, the inventive method and formulation provides a relatively consistent 5 mm envelope of penetration through the radiata heartwood, radiata sapwood and elliottii sapwood. Some of the elliottii heartwood samples did not show such a 5 mm envelope (coefficient of variation 32.73).

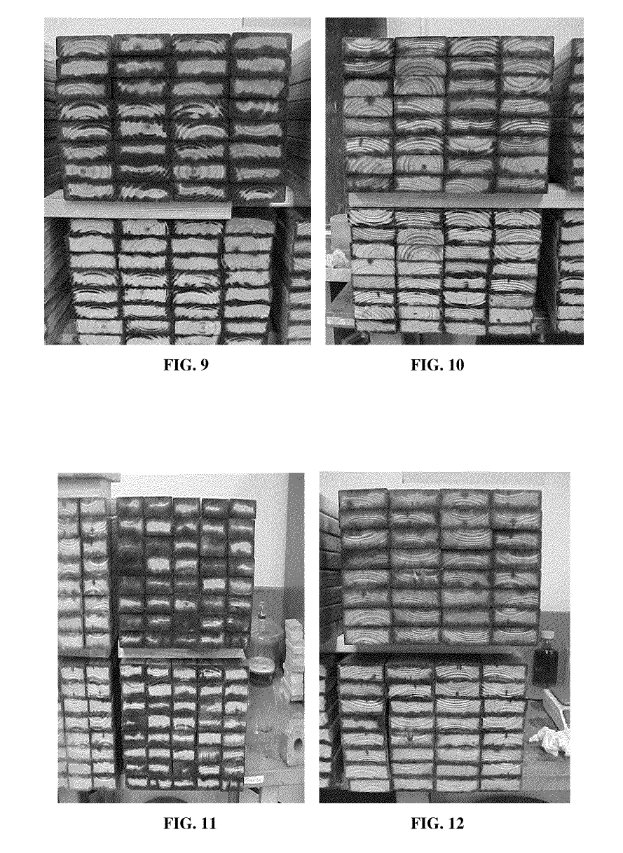

All samples, however, showed the “self-healing” effect 24 h later. FIGS. 9 to 12 provide an excellent, comparison of mobility/penetration within 24 h. The bottom stack is the treated wood product shown in FIGS. 1 to 4. The top stack is the radiata/elliottii heartwood/sapwood 24 h after the end cuts. The increased penetration of the carrier/preservative is clearly seen. The sell-healing effect is most obvious in the radiata sapwood shown in FIG. 11 and radiata heartwood shown in FIG. 9.

Use of the inventive carrier system comprising one or more biosolvents in the form of biodiesel having relatively low odour, relatively low volatile organic compound discharge and a relatively high flash point (>120° C.) embodies the following non-exhaustive list of advantages over comparative known methods and formulations: defined 5 mm protective envelope; self-healing; high flash point carrier will not evaporate; non-toxic; biodegradable; cheaper than using mineral oils such as heating oils; reproducible; and that the biodiesel is produced from a regenerable source and involves recycling otherwise waste products.

Although the invention has been described with reference to specific examples it will be appreciated by those skilled in the art that the invention may be embodied in many other forms.

It can be seen that the present invention provides a significant advantage over the prior art. The aforementioned discussion should in no way limit the scope of the invention and various other embodiments can be provided without departing from the spirit or scope of the invention.

1-44. (canceled)

45. A carrier composition for migration and/or redistribution of a preservative formulation within wood, said carrier composition comprising:
(a) a drying oil and/or a semi-drying oil; and
(b) an extender comprising one or more biosolvents.

46. A carrier composition according to claim 45, wherein said one or more biosolvents is in the form of biodiesel.

47. A carrier composition according to claim 46, wherein said biodiesel has relatively low odour, relatively low volatile organic compound discharge and a relatively high flash point (>120° C.).

48. A carrier composition according to claim 45, further comprising one or more drying agents to accelerate drying of said drying oil and/or said semi-drying oil.

49. A carrier composition according to claim 45, wherein said one or more drying agents is selected from the group consisting of: cobalt, manganese, zirconium, copper naphthenate, and mixtures thereof.

50. A carrier composition according to claim 45, wherein said drying oil is linseed oil, fish oil, or the like; or wherein said semi-drying oil is corn oil, cottonseed oil, sesame oil, or the like.

51. A carrier composition according to claim 45, wherein said extender is present in an amount between 1 and 99% w/w.

52. A carrier composition according to claim 45, wherein said extender is present in an amount between 40 and 60% w/w.

53. A carrier composition according to claim 45, wherein said carrier is selected to remain mobile within said wood for up to several months.

54. A carrier composition according to claim 45, wherein said carrier migrates and/or redistributes within said wood to exposed surfaces thereof.

55. A carrier composition according to claim 45, wherein said carrier migrates and/or redistributes along the grain of said wood and/or across said grain.

56. A formulation for treating wood comprising a preservative and a carrier composition, said carrier composition as defined according to claim 45, said formulation thereby mobile within the wood and providing for migration of the preservative within the wood to exposed surfaces thereof.

57. A formulation according to claim 56, wherein said preservative is selected from the group consisting of: insecticides, termiticides, fungicides, mouldicides, or the like, and mixtures thereof.

58. A formulation according to claim 56, wherein said preservative is selected from the group consisting of: organochlorine compounds, organophosphates, synthetic pyrethroids, neonicotinoids biological insecticides, imidacloprid, iodopropynylbuthylcarbamate (IPBC), organic tin compounds such as tributyltin naphthenate (TBTN), organic copper compounds such as copper 8 quinolinolate, copper naphthenate, organic zinc compounds, quaternary ammonium compounds, tertiary ammonium compounds, isothiazolones, triazoles such as tebuconazole, boron compounds, 3-benzothien-2-yl-5,6-dihydro-1,4,2-oxathiazine-4-oxide (Bethogard®) and bis-(N-cyclohexyldiazenuimdioxy) copper (“Cu-HDO”)”, and mixtures thereof.

59. A formulation according to claim 56, comprising below about 5% w/w preservative content.

60. A method of treating wood, said method comprising the step of contacting said wood with a formulation as defined according to claim 56.

61. A method according to claim 60, wherein said contacting step is effected by means selected from the group consisting of: pressure application, spraying, dipping, rolling and painting, and combinations thereof.

62. A method according to claim 60, wherein said contacting step is effected by means of dipping said wood in said formulation for a period of between a few seconds up to several minutes.

63. A method according to claim 60, wherein said wood is contacted with a sufficient quantity of said formulation to provide an uptake of between about 10 L/m³ to about 100 L/m³.

64. A method according to claim 60, wherein said wood is selected from the group consisting of: pinus radiata heartwood, pinus radiata sapwood, pinus elliottii heartwood, pinus elliottii sapwood, Douglas fir (psuedotsuga menziesii) heartwood, Douglas fir (psuedotsuga menziesii) sapwood and wood composites/engineered wood products such as particle board, plywood, medium density fibreboard (MDF) and oriented strand board (OSB).
